(19) United States
(12) Patent Application Publication
(10) Pub. No.: US 2014/0244171 A1
(43) Pub. Date: Aug. 28, 2014

(54) NAVIGATION SYSTEM AND METHOD

(71) Applicant: Quanta Computer Inc., Kuei Shan Hsiang (TW)

(72) Inventor: Kang-Wen Lin, Kuei Shan Hsiang (TW)

(73) Assignee: Quanta Computer Inc., Kuei Shan Hsiang (TW)

(21) Appl. No.: 14/046,035

(22) Filed: Oct. 4, 2013

(30) Foreign Application Priority Data
Feb. 22, 2013 (TW) 102106132

(51) Int. Cl. G01C 21/34

(52) U.S. Cl. CPC G01C 21/3484
USPC 701/537

(57) ABSTRACT

A navigation system and a navigation method are provided. The navigation method includes: receiving, by a receiving unit of a server, driving information according to a route from an electronic device; analyzing, by a feature-analysis unit of the server, the driving information and determining that the driving information belongs to a group in driver information corresponding to the route; and obtaining, by an optimization unit of the server, a best route from the group according to a starting point and a destination input by the electronic device, and transmitting the best route to the electronic device for navigation.

### CROSS REFERENCE TO RELATED APPLICATIONS

This Application claims priority of Taiwan Patent Application No. 102106132, filed on Feb. 22, 2013, the entirety of which is incorporated by reference herein.

### BACKGROUND OF THE INVENTION

1. Field of the Invention

The invention relates to a navigation system and method, and more particularly to a navigation system and method for analyzing the driving behavior of a user though cloud computing and combining community information to provide a navigation route to the user.

2. Description of the Related Art

For many drivers, navigation systems installed in their vehicles are becoming indispensable in daily life. A navigation system can integrate real-time traffic conditions with route navigation. Many navigation systems can also dynamically modify routes according to the latest traffic information, so that drivers can avoid traffic congestion, thus improving the quality of navigation.

With changes in real-time traffic, these navigation systems can provide real-time navigation directions to the driver according to traffic conditions, such as the status of road traffic, traffic flow, the location of road construction, traffic accidents, and so on. However, after receiving the latest recommendations for avoiding the most congested roads, the driver does not necessarily obey the recommendations generated by the navigation system. Because the driver may prefer some certain road types, for example, novice drivers may be not willing to drive down a small roadway, even if the small roadway may be not congested, or female drivers may not be willing to drive down a remote road for reasons of personal security, or drivers may drive slowly when not familiar with a road they are traveling for the first time, such as mountain roads having many curves. The situations described above may cause the driver to refuse to follow the recommendations generated by the navigation system. The navigation system may be unable to provide its full effectiveness because the navigation system may not provide better driving routes to the driver according to the driving preferences of the individual driver.

### BRIEF SUMMARY OF THE INVENTION

A detailed description is given in the following embodiments with reference to the accompanying drawings.

A navigation system and method are provided.

In one exemplary embodiment, the disclosure is directed to a navigation system. The navigation system comprises a server. The server comprises: a receiving unit, a feature-analysis unit and an optimization unit. The receiving unit is configured to receive driving information according to a route from an electronic device. The feature-analysis unit is coupled to the receiving unit and is configured to analyze the driving information to determine that the driving information belongs to a group in driver information corresponding to the route. The optimization unit is coupled to the feature-analysis unit and is configured to obtain a best route from the group according to a starting point and a destination input by the electronic device, and to transmit the best route to the electronic device for navigation.

In one exemplary embodiment, the disclosure is directed to a navigation method, comprising: receiving, by a receiving unit of a server, driving information according to a route from an electronic device; analyzing, by a feature-analysis unit of the server, the driving information and determining that the driving information belongs to a group in driver information corresponding to the route; and obtaining, by an optimization unit of the server, a best route from the group according to a starting point and a destination input by the electronic device, and transmitting the best route to the electronic device for navigation.

### BRIEF DESCRIPTION OF THE DRAWINGS

The invention can be more fully understood by reading the subsequent detailed description and examples with references made to the accompanying drawings, wherein:

FIG. 1 is a schematic diagram of a navigation system according to an embodiment of the present invention;

FIG. 2 is a schematic diagram of a navigation system according to another embodiment of the present invention; and

FIG. 3 is a flow diagram illustrating a navigation method according to an embodiment of the present invention.

### DETAILED DESCRIPTION OF THE INVENTION

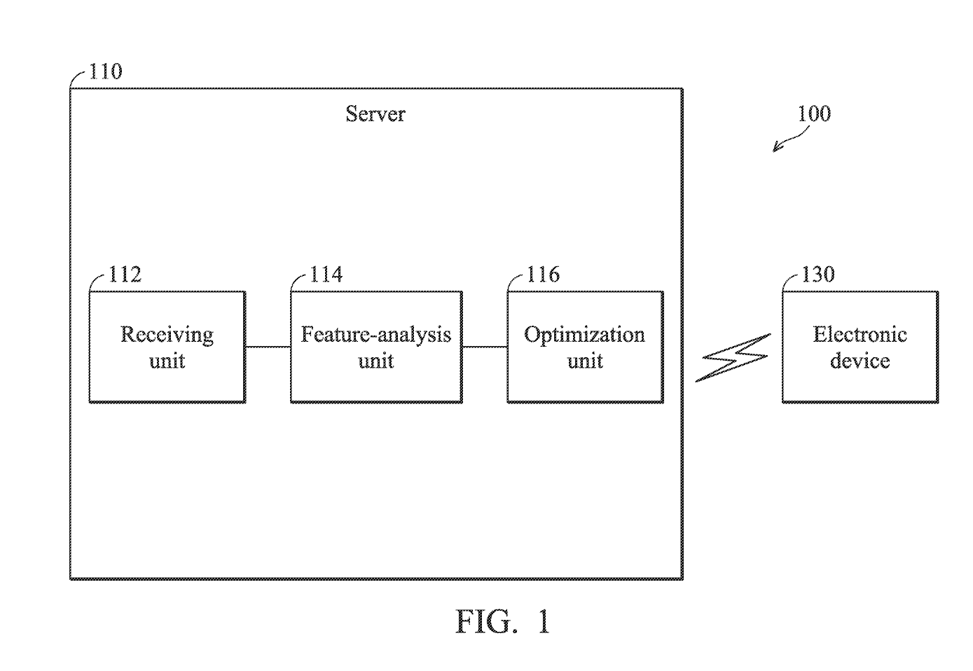

Several exemplary embodiments of the application are described with reference to FIGS. 1 through 3, which generally relate to a navigation system and a navigation method. It is understood that the following disclosure provides various different embodiments as examples for implementing different features of the application. Specific examples of components and arrangements are described in the following to simplify the present disclosure. These are, of course, merely examples and are not intended to be limited. In addition, the present disclosure may repeat reference numerals and/or letters in the various examples. This repetition is for the purpose of simplicity and clarity and does not in itself dictate a relationship between the various described embodiments and/or configurations.

FIG. 1 is a schematic diagram of a navigation system 100 according to an embodiment of the present invention. The navigation system 100 at least comprises a server 110 (such as a cloud server) and an electronic device 130. The server 110 processes information through cloud computing technology, wherein the server 110 can receive and store large amounts of traffic information in the cloud, and can speed up the data processing to provide the related navigation and route information in real time to the drivers. The server 110 comprises a receiving unit 112, a feature analyzing unit 114 and an optimization unit 116. The feature analyzing unit 114 is coupled to the receiving unit 112 and the optimization unit 116.

The electronic device 130 may be installed in the vehicle, which can be an intelligent terminal, a mobile phone, a personal digital assistant (PDA), or another device configured with Global Positioning System (GPS) devices, sensors sensing vehicle-related information (not shown in FIG. 1), and so on. The electronic device 130 can generate driving information by a satellite positioning system and the sensors according to a route, and continue to transmit the driving information, generated while the vehicle is in motion, to the server 110, wherein the driving information may include location information, velocity information, time information, road information, user-behavior information, and so on. For example, the location information and the time information can be obtained from the current position (latitude and longitude) according to the satellite receiving signals received by the GPS from a plurality of GPS satellites. The velocity information can be obtained by an accelerometer or a speedometer, or be calculated according to the distance of the route obtained from the location information and the travel time obtained from the time information. The road information can be obtained and updated from the road or highways bureau through the Internet, wherein the road information indicates all type of roads, such as motorways, mountain roads, ways, tunnels, streets, lanes, avenues, and so on, and may also comprise the number of road signs (such as traffic signals) or the number of turns the vehicle makes as it travels the route. The user-behavior information indicates the driving behavior of the driver corresponding to the route. For example, the driver can select different travel or driving routes between the same starting point and the same destination during different time intervals (such as peak hours and non-peak hours of the working day).

The receiving unit 112 of the server 110 is configured to receive the driving information generated by the electronic device 130. The feature-analysis unit 114 analyzes the driving information and determines that the driving information belongs to a group in driver information corresponding to the same route (i.e. the same starting point and the same destination). For example, Table 1 illustrates how the server 110 creates the driver information of the drivers using the navigation system in advance.

TABLE 1

| | | | | | | | Num- |
|---|---|---|---|---|---|---|---|
| | Starting | | Velocity | | | Time | ber |
| | point → | | (km/ | | Time | Inter- | of |
| Driver | Destination | Roads | hr) | Turns | (min) | val | Times |
| User | Taipei → | motorway | 80 | 8 | 32 | 4:00~ | 215 |
| | Taoyuan | | | | | 5:00 | |
| Driver I | Taipei → | way | 40 | 16~20 | 70 | 7:00~ | 6 |
| | Taoyuan | | | | | 9:00 | |
| Driver | Taipei → | way | 62 | 10~14 | 65 | 7:00~ | 400 |
| II | Taoyuan | | | | | 9:00 | |
| Driver | Taipei → | motorway | 75 | 5~9 | 40 | 22:00~ | 2000 |
| III | Taoyuan | | | | | 23:00 | |
| . . . | . . . | . . . | . . . | . . . | . . . | . . . | . . . |
| Driver | Taipei → | motorway | 75 | 5~9 | 80 | 7:00~ | 1500 |
| N | Taoyuan | | | | | 9:00 | |

“Starting point→Destination” described above can be obtained according to the location information. In an embodiment, when the driver enters the vehicle and activates the electronic device 130, the electronic device 130 is connected to the server 110 and continues to transmit the related driving information to the server 110. The “number of times” represents the number of times that a specific driver drives down the route. For example, the number of times that the driver III in Table 1 travels along the route “Taipei→Taoyuan” is 2000, it means that the driver III travels along the route almost every day.

When the feature-analysis unit 114 obtains all the driver information, the user can select one item of the driving information, or the server 110 can define one item of the driving information in advance as the main condition to be analyzed by the feature-analysis unit 114. The feature-analysis unit 114 divides all the driver information into a plurality of groups according to the main condition, wherein each group corresponds to a sensing range. The feature-analysis unit 114 determines one of the sensing ranges that corresponds to the electronic device 130 according to the driving information of the electronic device 130, and obtains the group according to the determined sensing range. For example, the user selects the item of “velocity” information as the main condition for analysis. Table 2 illustrates how the feature-analysis unit 114 divides all the driver information of the same route into a Group I, Group II, and Group III according to the velocity information.

TABLE 2

| | Velocity | | |
|---|---|---|---|
| Driver | Information | Sensing Range | Feature |
| User | 80 km/hr | | Fast |
| Group I | 40 km/hr | Below 49 km/hr | Slow |
| Group II | 62 km/hr | 50~70 km/hr | Normal |
| Group III | 75 km/hr | Above 71 km/hr | Fast |

The feature-analysis unit 114 divides the velocity information of all the driver's drives down the route into three groups, fast, normal, and slow, corresponding to different sensing ranges. The velocity information corresponding to the sensing range below 49 km/hr belongs to Group I, the velocity information corresponding to the sensing range of 50˜70 km/hr belongs to Group II, and the velocity information corresponding to the sensing range above 71 km/hr belongs to Group III. As shown in Table 2, the velocity information of the user is 80 km/hr and corresponds to the sensing range above 71 km/hr in Table 2, and therefore the user belongs to Group III (fast).

It must be noted that the number of drivers and groups described above is not limited to the embodiments and the figures shown in this invention. In addition, the feature-analysis unit 114 can further adjust the range of the sensing range so that all the features of the drivers can be finely analyzed. Moreover, the route that the user drives down must be the same as the route in the field “Starting point→Destination” when the feature-analysis unit 114 determines the group that the user corresponds to, it means that the drivers driving down the route “Taipei→Taoyuan” can be analyzed by the feature-analysis unit 114 and be divided into groups. Therefore, the results generated by the feature-analysis unit 114 are more accurate.

Once another starting point and another destination (for example, the starting point is Taoyuan and the destination is Taichung) is input from the electronic device 130, the optimization unit 116 obtains the best route between the input starting point and the input destination (i.e. the best route is selected from all the routes from Taoyuan to Taichung)) from the corresponding group (fast) after the feature-analysis unit 114 determines that the driving information of the electronic device 130 corresponds to a certain group (fast). Specifically, in the embodiment, the optimization unit 116 may find the drivers traveling from the starting point (Taoyuan) to the destination (Taichung) in the corresponding group, to obtain a plurality of candidate routes, and obtains the best route from among the candidate routes according to the weighting of each candidate route. Moreover, it should be noted that the best route from the starting point to the destination must be obtained from “the corresponding group”, because the routes selected by the drivers having similar characteristics in the same group are more appropriate for the user than the drivers in a different group.

For example, the feature-analysis unit 114 determines that the user belongs to the group “fast” (Group III, assuming that there are 50 drivers in Group III), and therefore the optimization unit 116 selects the routes the drivers have passed down from Group III as the candidate routes (assuming that the optimization unit 116 selects 45 routes, wherein maybe some drivers have not passed down the routes, and maybe a driver has passed down more than one route), wherein the routes pass from Taoyuan to Taichung. Next, the optimization unit 116 determines the best route from among the candidate routes according to the weighting of the candidate routes assigned in accordance with the driving information of the 45 routes. For example, the weighting factor of the number of times is 40%, the weighting factor of the time interval is 30%, the weighting factor of the time information is 20%, and the weighting factor of the road information is 10%. Finally, the optimization unit 116 may select the best route from the 45 routes according to the result after calculating the weights of the routes.

In an embodiment, the traffic conditions on the route may be in conformity with the driving preferences (fast) of the driver if the number of times that the driver has taken the route is large, and therefore the route has a higher weight.

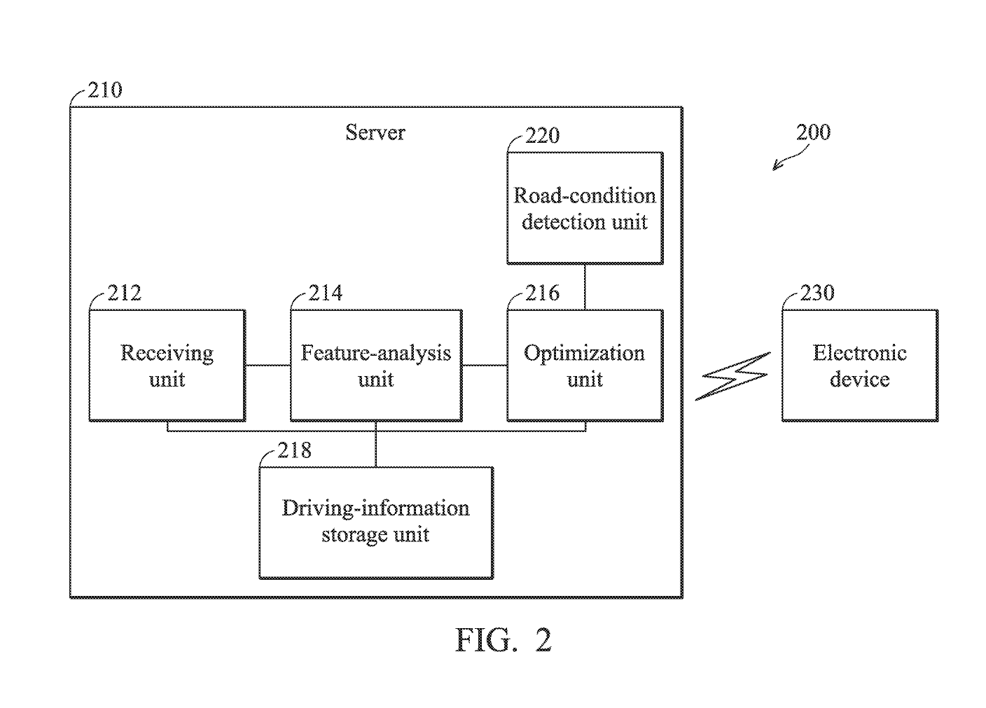

FIG. 2 is a schematic diagram of a navigation system 200 according to another embodiment of the present invention. The navigation system 200 at least comprises a server 210 and an electronic device 230. The server 210 comprises a receiving unit 212, a feature analyzing unit 214, an optimization unit 216, a driving-information storage unit 218 and a road-condition detection unit 220. The components having the same name as described in the embodiment of FIG. 1 have the same function, so the details related to the components of the navigation system will be omitted.

The main difference between FIG. 2 and FIG. 1 is that the server 210 further comprises the driving-information storage unit 218 and the road-condition detection unit 220.

In the embodiment, the driving-information storage unit 218 of the server 210 is coupled to the receiving unit 212, the feature-analysis unit 214 and the optimization unit 216 and is configured to store driving information for the driver using the navigation system 200. In simple terms, after receiving the driving information generated by the electronic device 230 installed in the vehicle, the receiving unit 212 transmits the driving information to the driving-information storage unit 218 for storage, and then the feature-analysis unit 214 may analyze the driving information. After analyzing the driving information, the feature-analysis unit 214 transmits the results of an analysis of the driving information to the driving-information storage unit 218 for storage. The driving-information storage unit 218 may collect the driving information of each driver so that other drivers may use and analyze the driving information to generate a navigation route, wherein the driving-information storage unit 218 may be a device or an apparatus which can store information such as, but not limited to, a hard disk drive, a memory, a Compact Disc (CD), a digital video disk (DVD), a computer, a server, or another device.

In the embodiment, the server 210 may further comprise the road-condition detection unit 220. The road-condition detection unit 220 is coupled to the optimization unit 216 and configured to receive traffic information of each road in real time. Specifically, the road-condition detection unit 220 can obtain the traffic information generated by monitoring devices installed on roads or received from the roads or freeways bureau, Google maps, etc, in real time to obtain the traffic condition of each road. The monitoring device may be a photographic device or another sensing device, and therefore the optimization unit 216 may consider the traffic conditions of each road to provide the driving information of the best route to the driver when finding the best route.

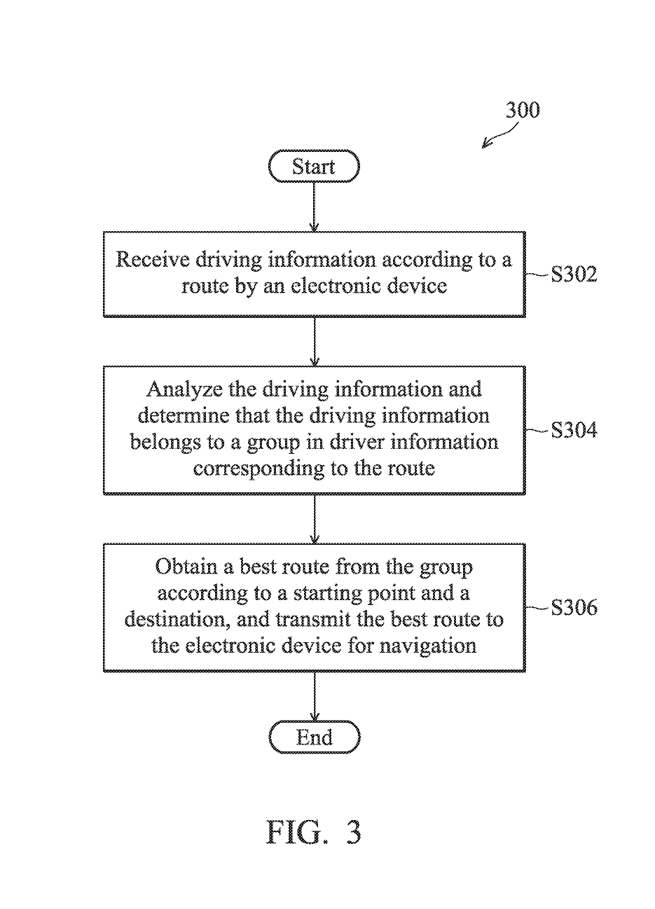

FIG. 3 is a flow diagram 300 illustrating a navigation method according to an embodiment of the present invention. First, in step S302, a receiving unit of a server receives driving information according to a route from an electronic device. Then, in step S304, a feature-analysis unit of the server analyzes the driving information and determines that the driving information belongs to a group in driver information corresponding to the route. Finally, in step S306, an optimization unit of the server obtains a best route from the group according to a starting point and a destination input by the electronic device, and transmits the best route to the electronic device for navigation.

Therefore, the navigation system and method in the present invention may provide the route information meeting the driving habits of the driver to the driver, and transmit the driving information to the server through the electronic device. The driving information may be analyzed and processed by the server of the navigation system to provide the route information to the driver. In addition, the driver can further adjust the driving conditions according to his/her own driving requirements so that the route obtained by the server can meet the requirements of the driver.

The above paragraphs describe many aspects of the invention. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A navigation system, comprising:
a server, comprising:
a receiving unit, configured to receive driving information according to a route from an electronic device;
a feature-analysis unit, coupled to the receiving unit and configured to analyze the driving information and determine that the driving information belongs to a group in driver information corresponding to the route; and
an optimization unit, coupled to the feature-analysis unit and configured to obtain a best route from the group according to a starting point and a destination input by the electronic device and transmit the best route to the electronic device for navigation.

2. The navigation system as claimed in claim 1, wherein the feature-analysis unit divides the driver information into a plurality of groups, wherein each group corresponds to a sensing range, determines one of the sensing ranges that corresponds to the driving information, and obtains the group according to the determined sensing range.

3. The navigation system as claimed in claim 1, the server further comprising:
a driving-information storage unit, coupled to the receiving unit, the feature-analysis unit and the optimization unit and configured to store the driver information and the driving information.

4. The navigation system as claimed in claim 1, wherein the optimization unit obtains a plurality of candidate routes from the group, and obtains the best route from among the candidate routes according to a weighting of each candidate route,
wherein the plurality of candidate routes includes the starting point and the destination.

5. The navigation system as claimed in claim 1, wherein the driving information includes location information, velocity information, time information, road information, and user-behavior information.

6. The navigation system as claimed in claim 1, the server further comprising:
a road-condition detection unit, coupled to the optimization unit and configured to receive traffic information.

7. A navigation method, comprising:
receiving, by a receiving unit of a server, driving information according to a route from an electronic device;
analyzing, by a feature-analysis unit of the server, the driving information and determining that the driving information belongs to a group in driver information corresponding to the route; and
obtaining, by an optimization unit of the server, a best route from the group according to a starting point and a destination input by the electronic device, and transmitting the best route to the electronic device for navigation.

8. The navigation method as claimed in claim 7, further comprising:
dividing, by the feature-analysis unit, the driver information into a plurality of groups, wherein each group corresponds to a sensing range, determining one of the sensing ranges that corresponds to the driving information, and obtaining the group range according to the determined sensing range.

9. The navigation method as claimed in claim 7, wherein the step of obtaining the best route by the optimization unit further comprises:
obtaining, by the optimization unit, a plurality of candidate routes from the group and obtaining the best route from among the candidate routes according to a weighting of each candidate route,
wherein the plurality of candidate routes includes the starting point and the destination.

10. The navigation method as claimed in claim 7, wherein the driving information includes location information, velocity information, time information, road information, and user-behavior information.
